(19) United States
(12) Patent Application Publication
(10) Pub. No.: US 2015/0311939 A1
(43) Pub. Date: Oct. 29, 2015

(54) CARRYING CASE FOR MOBILE TELEPHONES

(71) Applicant: SPARK STUDIOS, LLC, Fairfield, CT (US)

(72) Inventors: Paul Zalon, Fairfield, CT (US); David DOMOGALA, Fairfield, CT (US)

(21) Appl. No.: 14/615,178

(22) Filed: Feb. 5, 2015

Related U.S. Application Data
(60) Provisional application No. 61/936,159, filed on Feb. 5, 2014.

(51) Int. Cl. H04B 1/3888; F21V 8/00; F21L 4/02; F21V 23/04; F21V 33/00

(52) U.S. Cl. CPC H04B 1/3888; F21V 23/0464; F21V 33/0056; F21L 4/02; G02B 6/0008; F21Y 2101/02

(57) ABSTRACT

A carrying case for carrying a mobile telephone, comprises an outer casing defining an inner cavity for removably storing the mobile telephone within the inner cavity, a light source configured to selectively generate a light visible from the outside of the carrying case, a source of electrical energy, a sensor electrically connected to the electrical battery and the light source, and configured to detect a light level or a vibration level within the inner cavity of the carrying case, and an electronic control unit electrically connected to the source of electrical energy and the sensor. The electronic control unit is configured to automatically turn the light source on when a light level or a vibration level within the inner cavity of the carrying case detected by the sensor is above a predetermined level. The outer casing has an outer wall and an access opening into the inner cavity.

### CROSS-REFERENCE TO RELATED APPLICATIONS

This application claims the benefit of priority of U.S. provisional application No. 61/936,159 filed on Feb. 5, 2014 by Paul Zalon and David Domogala, which is hereby incorporated herein by reference in its entirety and to which priority is claimed.

### BACKGROUND OF THE INVENTION

1. Field of the Invention

The present invention relates generally to carrying cases in general and, more particularly, to a carrying case for mobile phones illuminated by lighting elements.

2. Description of the Related Art

Mobile phones are extremely popular with the users. The mobile phones are portable and easy to put in bags or pockets. Specialized carrying cases have been designed for storing and protecting the mobile phones. These carrying cases generally include a custom shape, interior pocket or the like that conforms to the shape of the mobile phones and can provide an additional degree of padding or cushioning therefor. The conventional carrying cases have fixed patterns, shapes and ornamental designs. However, conventional carrying cases for mobile phones are susceptible to improvements. With this in mind, a need exists to develop a carrying case for mobile phones with illuminated display that advances the art.

### SUMMARY OF THE INVENTION

The object of the invention is to provide a carrying case for carrying a mobile telephone. The carrying case comprises a hollow outer casing defining an inner cavity sized for fully receiving and removably storing the mobile telephone within the inner cavity, at least one light source configured to selectively generate a light visible from the outside of the carrying case, a source of electrical energy, a sensor electrically connected to the electrical battery and the at least one light source, and configured to detect a light level or a vibration level within the inner cavity of the carrying case, and an electronic control unit electrically connected to the source of electrical energy and the sensor. The outer casing 12 has an outer wall and an access opening into the inner cavity thereof. The electronic control unit is configured to automatically turn the at least one light source on when a light level or a vibration level within the inner cavity of the carrying case detected by the sensor is above a predetermined level.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. The objects and advantages of the invention will become apparent from a study of the following specification when viewed in light of the accompanying drawings, in which like elements are given the same or analogous reference numerals and wherein:

FIG. 1A is a front view of a carrying case according to a first exemplary embodiment of the present invention with an ornamental graphic image;

FIG. 1B is a front view of the carrying case according to the first exemplary embodiment of the present invention without the ornamental graphic image;

FIG. 2A is a rear view of the carrying case according to the first exemplary embodiment of the present invention with the ornamental graphic image;

FIG. 2B is a rear view of the carrying case according to the first exemplary embodiment of the present invention without the ornamental graphic image;

FIG. 3 shows an inside view of a front portion of an outer casing of the carrying case according to the first exemplary embodiment of the present invention;

FIG. 4 shows an inside view of a rear portion of the outer casing of the carrying case according to the first exemplary embodiment of the present invention;

FIG. 5 is a sectional view of the front portion of the outer casing of the carrying case according to the first exemplary embodiment of the present invention;

FIG. 6 is an exploded perspective view of the front portion of the outer casing of the carrying case according to the first exemplary embodiment of the present invention;

FIG. 7 an inside view of a front portion of an outer casing of a carrying case according to a second exemplary embodiment of the present invention;

FIG. 8 is a sectional view of the front portion of the outer casing of the carrying case according to the second exemplary embodiment of the present invention;

FIG. 9 is a front view of a carrying case according to a third exemplary embodiment of the present invention; and

FIG. 10 is a sectional view of the front portion of the outer casing of the carrying case according to the third exemplary embodiment of the present invention.

### DETAILED DESCRIPTION OF EXEMPLARY EMBODIMENT(S) AND EMBODIED METHOD(S) OF THE INVENTION

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal,” “vertical,” “up,” “down,” “upper,” “lower,” “right,” “left,” “top,” and “bottom” as well as derivatives thereof (e.g., “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. Additionally, the words “a” and “an” as used in the claims mean “at least one”.

FIGS. 1-6 depict a carrying case 10 for a mobile telephone (or phone) 2, according to a first exemplary embodiment of the present invention. The mobile phone 2 has a display screen 4 for displaying or viewing. Conventionally, the display screen 4 of the mobile telephone (or phone) 2 is lighted up to alerts a receiving party of a new, incoming call or a text message, and displays a telephone number of a calling party even when cell phones are turned onto a vibrate mode. Typically, all smart phones and most regular mobile phones have a display screen that lights up when an incoming call or a text message is received even if the phones are on a vibrate mode.

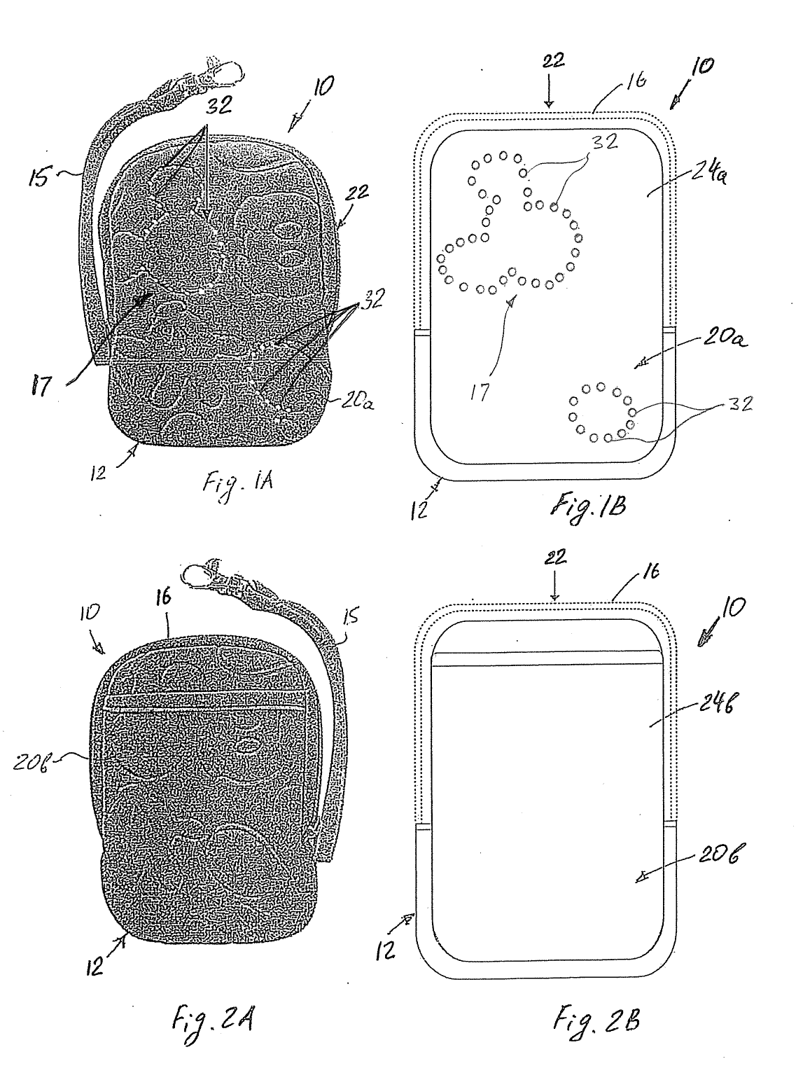

The carrying case 10 comprises a hollow outer casing 12 defining an inner cavity 14 therein. The inner cavity 14 is sized for fully receiving and removably storing the mobile telephone 2 within the inner cavity 14. The outer casing 12 has an opening edge 16 forming an access opening 18 into the inner cavity 14 of the outer casing 12. The access opening 18 is sized to permit the mobile telephone 2 to be inserted into and removed from the inner cavity 14. A strap 15 shown in FIGS. 1A and 2A can be provided as a means for carrying the carrying case 10. The outer casing 12 includes a front portion 20a and a rear portion 20b fixed to each other so as to define the inner cavity 14 in the outer casing 12 and to form the access opening 18 into the inner cavity 14. The front portion 20a and the rear portion 20b fixed to each other at peripheral edges thereof except for the opening edge 16 so as to form the access opening 18. The access opening 18 into the inner cavity 14 may be selectively open and closed using a fastener, such as a zipper 22. Other appropriate fasteners, such as a snap fastener, hook-and-loop fasteners (colloquially known as Velcro), etc., are within the scope of the present invention.

The front portion 20a of the outer casing 12 comprises an outer wall 24a and an inner liner 26a attached to the outer wall 24a to form the front portion 20a, while the rear portion 20b of the outer casing 12 comprises an outer wall 24b and an inner liner 26b attached to the outer wall 24b to form the rear portion 20b. The outer walls 24a, 24b of both front and rear portions 20a, 20b of the outer casing 12 are made of an opaque material, while the inner liner 26a of the front portion 20a of the outer casing 12 is made of a translucent (or transparent) material, such as a translucent fabric. Specifically, the outer walls 24a, 24b can be made of a rigid opaque material, such as plastic, or a substantially flexible opaque material, such as fabric, leather or vinyl. Moreover, an outer surface of the outer wall 24a of the front portion 20a of the outer casing 12 is provided with an ornamental graphic image 17, such as an advertising message, corporate logo or any artwork, embossed of otherwise formed on the outer wall 24a, as illustrated in FIG. 1A.

As illustrated in FIGS. 1A, 3, 5 and 6, a plurality of fiber optic strands 30 is disposed within the outer casing 12 between the outer wall 24a and the inner liner 26a of the front portion 20a of the outer casing 12. Fiber tips 32 of the fiber optic strands 30 extend through the outer wall 24a of the front portion 20a of the outer casing 12 so as to be visible from the outside of the carrying case 10. Therefore, the outer wall 24a of the front portion 20a of the outer casing 12 with the fiber optic strands 30 and the fiber tips 32 forms a display panel for producing a continuous animated display of the ornamental graphic image 17 utilizing sequenced illumination patterns or arrays of groups of optical fiber strands 30 in a pre-programmed, timed sequence to achieve one or more illumination techniques imparting continuous animated motion to the one or more images for producing steady lit, blinking, fading or desired animated motion on the outer wall 24a of the front portion 20a of the outer casing 12. The images are formed by the fiber tips 32 of the fiber optic strands 30 defining a series of illumination points formed in the shape of various ornamental and/or decorative images and/or letters.

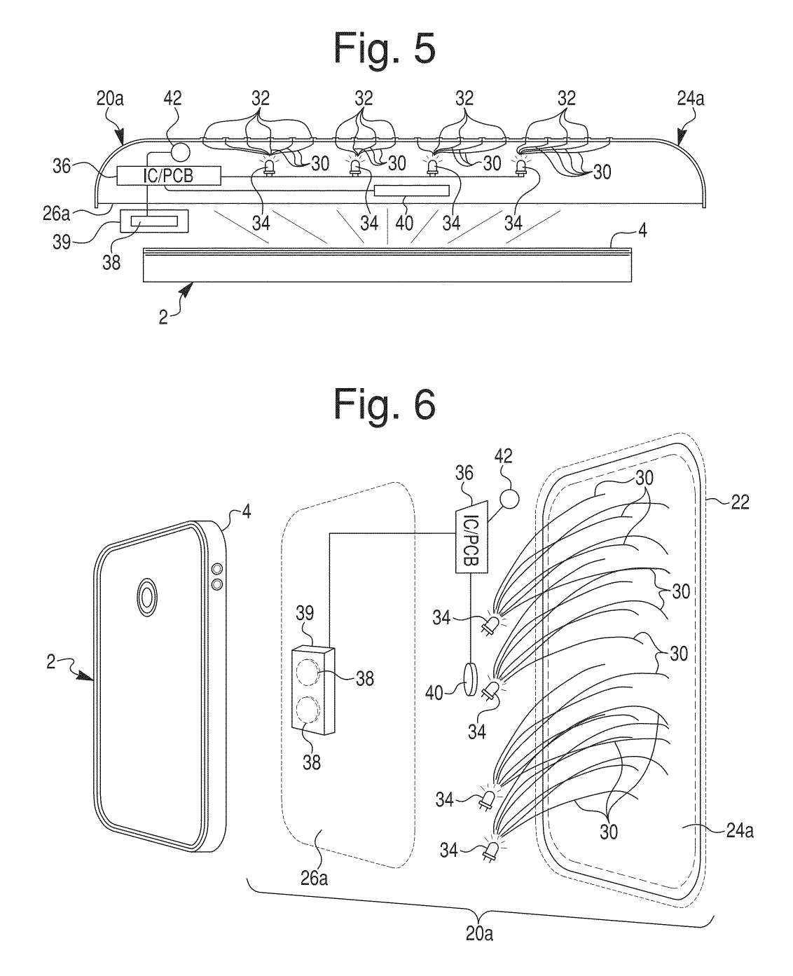

As shown in FIGS. 5 and 6, proximal ends of the fiber optic strands 30 are operatively linked to one or more light sources 34 disposed within the outer casing 12 between the outer wall 24a and the inner liner 26a of the front portion 20a of the outer casing 12. In other words, the fiber optic strands 30 are disposed within the outer casing 12 so as to extend between the outer wall 24a of the front portion 20a of the outer casing 12 and the light sources 34. The fiber optic strands 30 are configured to transmit the light from the light sources 34 to the outside of the carrying case 10. The effect is to be able to illuminate the ornamental graphic image 17 in any pre-programmed sequence. The light sources 34, according to the exemplary embodiment of the present invention, are the light emitting diodes (LEDs). It should be understood that any other appropriate low voltage light source, including colored light emitting diodes or colored lenses placed over the light emitting diodes to produce desired colors or electroluminescent bulbs, are within the scope of the present invention. The inner cavity 14 of the outer casing 12 further houses an electronic control unit 36, preferably in the form of an integrated circuit (IC) or a printed circuit board (PCB), electrically connected to the light sources 34 for controlling timing and sequencing of illumination of the light sources 34 so as to produce a continuous animated display of the ornamental graphic image 17 utilizing sequenced illumination patterns or arrays of groups of the optical fiber strands 30 in the pre-programmed, timed sequence to achieve one or more illumination techniques imparting continuous animated motion to the one or more images for producing steady lit, blinking, fading or the desired animated motion on the outer wall 24a of the front portion 20a of the outer casing 12. According to the exemplary embodiment of the present invention, the control unit 36 is disposed between the opaque outer wall 24a and the translucent inner liner 26a of the front portion 20a of the outer casing 12.

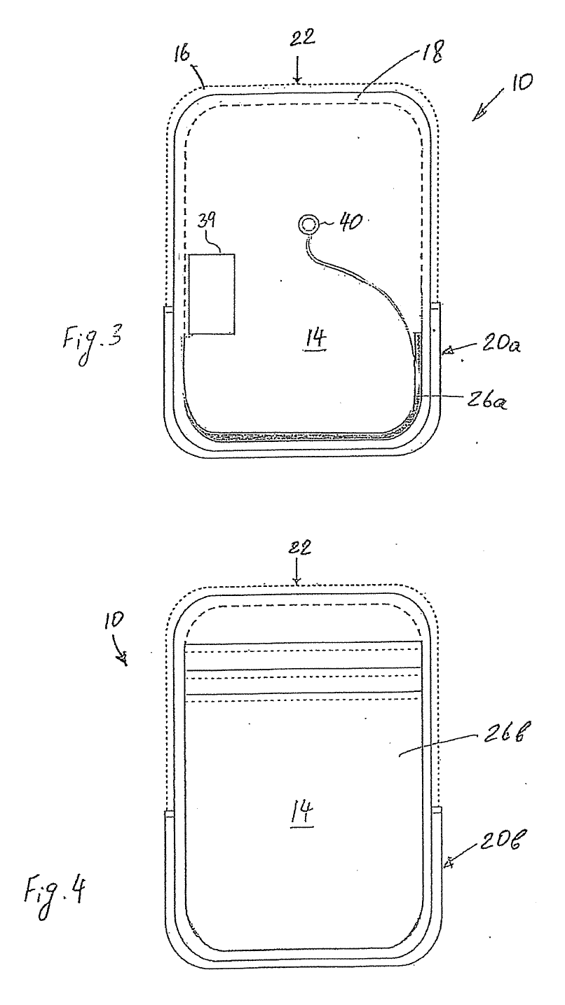

The carrying case 10 further comprises a source of electrical energy 38 disposed within the inner cavity 14, as best shown in FIGS. 3, 5 and 6. The source of electrical energy 38 may be an electrical battery, an electrical battery pack or similar portable energy source, provided to supply electrical energy to the LEDs 34 and the electronic control unit 36. According to the exemplary embodiment of the present invention, the electrical battery 38 is housed in a battery case 39. Thus, according to the exemplary embodiment of the present invention, the electrical battery 38 is mounted inside the battery case 39 disposed inside the inner cavity 14 of the outer casing 12, as best shown in FIG. 5. The electrical battery 38 may be replaceable or rechargeable. As further shown in FIGS. 3, 5 and 6, the battery case 39 is disposed inside the inner cavity 14 but outside the space between the outer wall 24a and the inner liner 26a of the front portion 20a of the outer casing 12 so as to facilitate replacement of the electrical battery 38.

The carrying case 10 further includes a light sensor 40 (photo-sensor or photodetector) electrically connected to the electronic control unit 36. The light sensor 40, such as, for example, a photocell, photo-resistor, etc., is provided to detect a light level, and is configured to automatically turn the LEDs 34 on if a light level within the inner cavity 14 of the carrying case 10 is above a predetermined level and to automatically turn the LEDs 34 off if the light level is below the predetermined level. Generally, the predetermined level may be chosen based upon an average light level within the inner cavity 14 of the carrying case 10 in a closed condition thereof. Specifically, the light sensor 40 is set so that the light level within the inner cavity 14 of the carrying case 10 is above the predetermined level when the display screen 4 of the mobile phone 2 is conventionally lighted (such as when the mobile phone 2 receives an incoming phone call or a text message, or when the carrying case 10 is in an open condition thereof), and the light level within the inner cavity 14 of the carrying case 10 is below the predetermined level when the display screen 4 of the mobile phone 2 is not lighted and the carrying case 10 is in the closed condition thereof. The light sensor 40 according to exemplary embodiment of the present invention is very sensitive and works when the brightness of the screen 4 of the mobile phone 2 is as low is as 25-30% power. It will be appreciated by those skilled in the art that the electronic control unit 36 may have a variable control (not shown) to set light sensitivity of the light sensor 40 to a desired level. Also, the LEDs 34 will automatically turn off after a predetermined time expires. According to the exemplary embodiment of the present invention, the LEDs 34, thus the illuminated ornamental graphic image 17, will automatically turn off after approximately 40-60 seconds. According to the exemplary embodiment of the present invention, the light sensor 40 is mounted between the opaque outer wall 24a and the translucent inner liner 26a of the front portion 20a of the outer casing 12, as illustrated in FIGS. 3, 5 and 6, so as to be consequently exposed to the ambient light inside the inner cavity 14 of the carrying case 10.

According to the exemplary embodiment of the present invention, the light sensor 40 is in the form of a photo-resistor, such as a cadmium sulfide (CDS) photo-resistor. An electrical resistance of the CDS photo-resistor varies as a function of the intensity of ambient light. According to the exemplary embodiment of the present invention, the LEDs 34 will be automatically switched on in high light conditions within the inner cavity 14 of the carrying case 10, as previously described.

The ornamental graphic image 17 on the front portion 20a of the outer casing 12 may be printed or embossed or embroidered or even be a “blind image” (which means that the ornamental graphic image 17 is not visible until the LEDs 34 light up and lit the fiber optic strands 30.

A speaker 42 is also disposed within the inner cavity 14 of the carrying case 10 and is controlled by the electronic control unit 36 to play additional pre-selected sound effects/and or music when a light level within the inner cavity 14 of the carrying case 10 is above the predetermined level, i.e., when an incoming call or a text message to the mobile telephone 2 is received, so as to alert the user of the incoming call or text message.

In operation, the mobile phone 2 is stored in inner cavity 14 of the outer casing 12 so that the screen 4 of the mobile phone 2 faces the inner liner 26a of the front portion 20a of the outer casing 12 (i.e., the screen 4 of the mobile phone 2 faces the light sensor 40), and the inner cavity 14 is in the closed condition thereof. If the mobile phone 2 receives no incoming phone call or a text message, the display screen 4 of the mobile phone 2 is not lighted, or dark. In other words, the light level within the inner cavity 14 of the carrying case 10 is below the predetermined level, thus, is insufficient to turn the LEDs 34 on. Subsequently, the LEDs 34 are turned off, and the ornamental graphic image 17 is not illuminated. However, if the mobile phone 2 receives an incoming phone call or a text message, the display screen 4 of the mobile phone 2 is conventionally lighted. The light of the lighted display screen 4 of the mobile phone 2 is above the predetermined level and activates the light sensor 40, thus, is sufficient to turn the LEDs 34 on. Subsequently, the LEDs 34 are turned on, and the ornamental graphic image 17 is illuminated in an animated manner (i.e., in a pre-programmed sequence) so as to alert the user that the phone is receiving an incoming phone call or a text message. Simultaneously, the electronic control unit 36 activates the speaker 42 so that the additional sound effects/and or music can be played by the speaker 42 when an incoming call or a text message to the mobile telephone 2 is received so as to alert the user of the incoming call or text message. The illuminated ornamental graphic image 17 will automatically turn off after approximately 40-60 seconds.

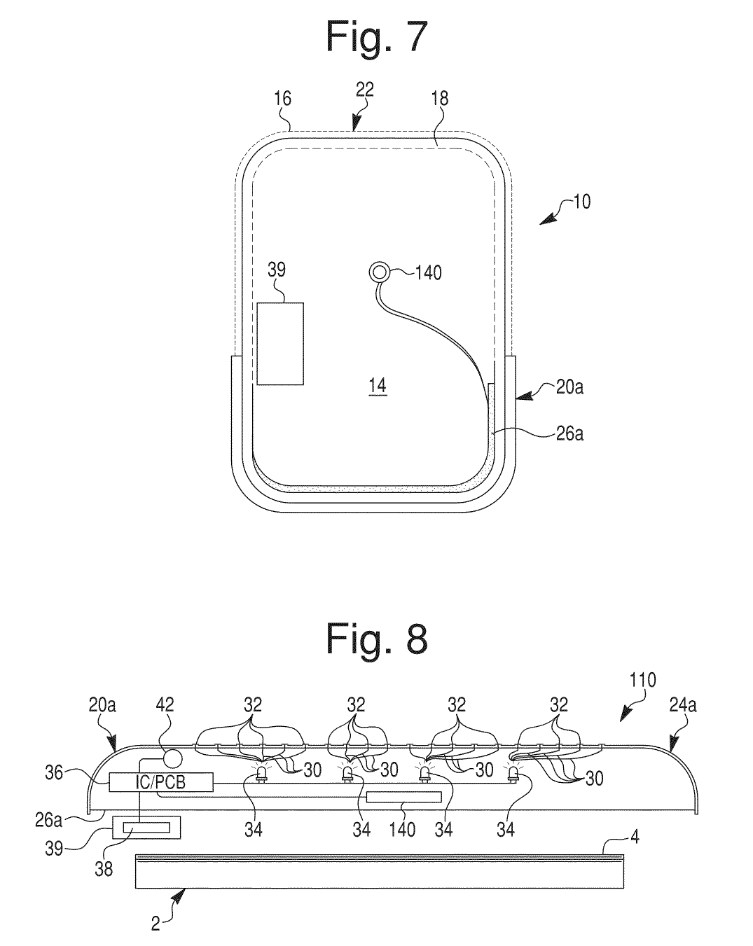

FIGS. 7 and 8 show a carrying case 110 according to a second exemplary embodiment of the present invention. Components, which are unchanged from, or function in the same way as in the exemplary embodiment depicted in FIG. 1A-6 are labeled with the same reference characters. The carrying case 110 of FIGS. 7 and 8 corresponds substantially to the carrying case 10 of FIGS. 1A-6, and only the portions, which differ, will therefore be explained in detail below. Modified components and parts are indicated by the addition of 100 to the reference numerals of the components or parts.

According to the second exemplary embodiment of the present invention, instead of or in addition to the light sensor 40, the carrying case 110 comprises a vibration sensor 140 electrically connected to the control unit 36 and provided for automatically turning the LEDs 34 on if a vibration level of the carrying case 10 is above a predetermined level and for turning the LEDs 34 off if the vibration level is below the predetermined level. This is particularly useful if the mobile phone 2, stored in inner cavity 14 of the outer casing 12, is in a vibration mode.

In operation, the mobile phone 2 does not vibrate if not receives an incoming phone call. In this case, the vibration level within the inner cavity 14 of the carrying case 10 is below the predetermined level, thus, is insufficient to turn the LEDs 34 on. Subsequently, the LEDs 34 are turned off, and the ornamental graphic image 17 is not illuminated. However, when the mobile phone 2 receives an incoming phone call, the mobile phone 2, consequently, vibrates. The vibration of the mobile phone 2 is above the predetermined level and activates the vibration sensor, thus, is sufficient to turn the LEDs 34 on. Subsequently, the LEDs 34 are turned on, and the ornamental graphic image 17 is illuminated in an animated manner (i.e., in a pre-programmed sequence) so as to alert the user that the phone is receiving a phone call.

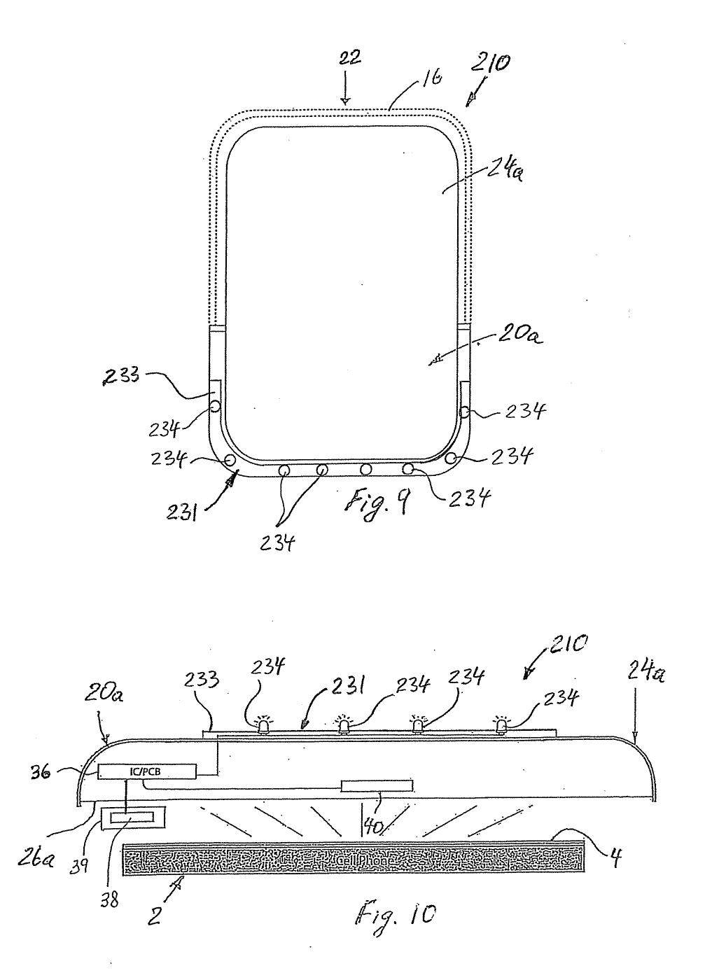

FIGS. 9 and 10 show a carrying case 210 according to a third exemplary embodiment of the present invention. Components, which are unchanged from, or function in the same way as in the exemplary embodiment depicted in FIG. 1A-6 are labeled with the same reference characters. The carrying case 210 of FIGS. 9 and 10 corresponds substantially to the carrying case 10 of FIGS. 1A-6, and only the portions, which differ, will therefore be explained in detail below. Modified components and parts are indicated by the addition of 200 to the reference numerals of the components or parts.

According to the third exemplary embodiment of the present invention, instead of the fiber optic strands 30 and the light source(s) 34 disposed within the outer casing 12, the carrying case 210 comprises an integrally-formed single-piece flexible light emitting diode (LED) light strip 231 attached to an outer surface of the outer wall 24a of the outer casing 12 so as to be visible from the outside of the carrying case 210. The flexible LED light strip 231 includes a flexible substrate 233 and one or more LED lights 234 mounted thereto. Moreover, the flexible LED light strip 231 is electrically connected to the control unit 36, which for automatically turns the LEDs 234 on if a light level within the inner cavity 14 of the carrying case 10 is above a predetermined level and automatically turns the LEDs 234 off if the light level is below the predetermined level. The flexible substrate 233 of the flexible LED light strip 231 is attached to the outer surface of the outer wall 24a by any appropriate means known in the art, such as by adhesive bonding.

The foregoing description of the exemplary embodiment(s) of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. A carrying case for carrying a mobile telephone, the carrying case comprising:
a hollow outer casing defining an inner cavity therein, the inner cavity sized for fully receiving and removably storing the mobile telephone within the inner cavity, the outer casing having an outer wall and an access opening into the inner cavity thereof;
at least one light source configured to selectively generate a light visible from the outside of the carrying case;
a source of electrical energy;
a sensor electrically connected to the electrical battery and the at least one light source, the sensor being configured to detect a light level or a vibration level within the inner cavity of the carrying case; and
an electronic control unit electrically connected to the source of electrical energy and the sensor;
the electronic control unit configured to automatically turn the at least one light source on when a light level or a vibration level within the inner cavity of the carrying case detected by the sensor is above a predetermined level.

2. The carrying case as defined in claim 1, wherein the sensor is a light sensor for detecting a light level; wherein the outer casing further comprises an inner liner attached to the outer wall; wherein the outer wall is made of an opaque material; wherein the inner liner is made of a translucent or transparent material; and wherein the light sensor is disposed between the opaque outer wall and the translucent or transparent inner liner of the outer casing.

3. The carrying case as defined in claim 1, wherein the electronic control unit configured to automatically turn the at least one light source off when the light level within the inner cavity is below the predetermined level.

4. The carrying case as defined in claim 1, wherein the electronic control unit automatically turns the at least one light source off after a predetermined time expires.

5. The carrying case as defined in claim 1, wherein the electronic control unit is further configured to control timing and sequencing of illumination of the at least one light source.

6. The carrying case as defined in claim 1, further comprising a re-sealable closure fastener attached to the outer casing for selectively closing and opening the access opening.

7. The carrying case as defined in claim 6, wherein the re-sealable closure fastener is a zipper affixed to the outer casing adjacent the access opening.

8. The carrying case as defined in claim 1, wherein the at least one light source is a light emitting diode (LED).

9. The carrying case as defined in claim 1, further comprising a speaker disposed within the inner cavity of the carrying case and controlled by the electronic control unit to play sound effects or music when the light level within the inner cavity of the carrying case is above the predetermined level.

10. The carrying case as defined in claim 1, wherein the at least one light source is disposed within the outer casing so as to selectively generate a light visible from the outside of the carrying case.

11. The carrying case as defined in claim 10, further comprising at least one fiber optic strand disposed within the outer casing so that a fiber tip of the at least one fiber optic strand extends through the outer wall of the outer casing so as to be visible from the outside of the carrying case; wherein the at least one fiber optic strand extends between the outer wall of the outer casing and the at least one light source and is configured to transmit the light from the at least one light source to the outside of the carrying case.

12. The carrying case as defined in claim 11, wherein the outer casing further comprises an inner liner attached to the outer wall; wherein the inner liner is made of a translucent or transparent material; wherein the outer wall is made of an opaque material; and wherein the light sensor and the at least one light source are disposed between the opaque outer wall and the translucent or transparent inner liner of the outer casing.

13. The carrying case as defined in claim 10, wherein the at least one light source includes a plurality of the light sources each disposed within the outer casing so as to selectively generate a light visible from the outside of the carrying case.

14. The carrying case as defined in claim 13, further comprising a plurality of fiber optic strands disposed within the outer casing so that fiber tips of the fiber optic strands extend through the outer wall of the outer casing so as to be visible from the outside of the carrying case; wherein each of the fiber optic strands extends between the outer wall of the outer casing and one of the plurality of the light sources and is configured to transmit the light from one of the plurality of the light sources to the outside of the carrying case.

15. The carrying case as defined in claim 14, wherein the outer casing further comprises an inner liner attached to the outer wall; wherein the inner liner is made of a translucent or transparent material; wherein the outer wall is made of an opaque material; and wherein the light sensor and the plurality of the light sources are disposed between the opaque outer wall and the translucent or transparent inner liner of the outer casing.

16. The carrying case as defined in claim 1, wherein the at least one light source is mounted to the outer wall of the outer casing.

17. The carrying case as defined in claim 16, wherein the outer casing further comprises an inner liner attached to the outer wall; wherein the inner liner is made of a translucent or transparent material; wherein the outer wall is made of an opaque material; and wherein the light sensor is disposed between the opaque outer wall and the translucent or transparent inner liner of the outer casing.

18. The carrying case as defined in claim 17, wherein the at least one light source includes a plurality of light sources each mounted to the outer wall of the outer casing so as to selectively generate a light visible from the outside of the carrying case.

19. The carrying case as defined in claim 18, wherein the plurality of the light sources are mounted to a flexible substrate attached to the outer wall of the outer casing.

20. The carrying case as defined in claim 1, wherein the source of electrical energy is an electrical battery.
